(19) United States
(12) Patent Application Publication
(10) Pub. No.: US 2019/0387916 A1
(43) Pub. Date: Dec. 26, 2019

(54) Coffee Press with Lipids Separation Chamber

(71) Applicants: Gina Tempelis, Bristolville, OH (US); Donald Petronelli, Bristolville, OH (US)

(72) Inventors: Gina Tempelis, Bristolville, OH (US); Donald Petronelli, Bristolville, OH (US)

(21) Appl. No.: 16/481,661

(22) PCT Filed: Jan. 24, 2018
(86) PCT No.: PCT/US18/15031

§ 371 Date: Jul. 29, 2019

Related U.S. Application Data
(60) Provisional application No. 62/452,275, filed on Jan. 30, 2017.

(51) Int. Cl. A47J 31/20

(52) U.S. Cl. CPC A47J 31/20

(57) ABSTRACT

A beverage brewing apparatus has a first container with a first lower end, a first upper end, and a first sidewall extending between the first lower end and the first upper end defining a primary chamber. The beverage brewing apparatus further includes a second container connected to the first container, the second container having a second lower end, a second upper end, and a second sidewall extending between the second lower end and the second upper end defining a secondary chamber. A lid encloses the first upper end and has a plunger movable relative to the lid, the plunger being movably disposed between the first upper end and the first lower end. The secondary chamber is in fluid communication with the primary chamber via a passage proximate to the first lower end and the second lower end.

### CROSS-REFERENCE TO RELATED APPLICATIONS

This application claims priority to U.S. Provisional Application No. 62/452,275, filed on Jan. 30, 2017, the disclosure of which is herein incorporated by reference in its entirety.

### BACKGROUND OF THE DISCLOSURE

### Field of the Disclosure

The present disclosure is generally related to a beverage brewing apparatus, and, in particular, to a French press coffee maker having a primary brewing chamber and a secondary chamber configured to reduce or eliminate the passage of lipid constituents suspended in a beverage, such as brewed coffee, tea, cocoa, chocolate and or any other infusible product from the primary brewing chamber.

### Description of Related Art

A variety of beverage brewing devices exist for preparing infused beverages, such as coffee-based drinks Δn example of a coffee brewing device is a French press coffee maker. Such a device generally includes a cylindrical container, usually made of glass, clear plastic, or metal, and a lid for enclosing the container. The lid has a plunger that fits tightly within the container. The plunger has a filter to allow for passage of liquid through the filter as the plunger is moved within the container. Coffee is brewed by placing coarsely ground coffee beans in the container and adding hot water to the container. The plunger is moved in a first or upper position proximate to the open end of the container. After allowing a sufficient time for brewing, the plunger moved to the second or lower position toward the bottom end of the container. Movement of the plunger separates the coffee grounds from the liquid coffee extract by allowing the liquid coffee extract to pass through the filter while holding the coffee grounds at the bottom of the container.

A disadvantage of conventional French press coffee makers is that the brewed coffee may have a very strong and bitter taste, partially because of the presence of various oils that are released from the ground coffee beans during the brewing process. For example, diterpene oil, such as cafestol or kahweol, is released from the ground coffee beans and is accumulated on top of the liquid coffee extract due to its lower density. When consumed, diterpene oil raises cholesterol levels by hijacking a receptor in an intestinal pathway critical to its regulation. With increased coffee intake, cholesterol levels can be increased to an undesirable level, thereby potentially contributing to adverse health effects. Accordingly, in view of these and other disadvantages of conventional French press coffee makers, there is a need in the art for an improved French press coffee maker that overcomes these shortcomings and provides a device that decreases or eliminates the presence of diterpene oil and other lipid constituents in brewed coffee.

### SUMMARY OF THE DISCLOSURE

The present disclosure generally relates to a beverage brewing apparatus, and, in particular, to a French press coffee maker having a primary brewing chamber and a secondary chamber configured to reduce or eliminate the passage of lipid constituents suspended in brewed coffee from the primary brewing chamber.

In some examples of the present disclosure, a beverage brewing apparatus may have a first container with a first lower end, a first upper end, and a first sidewall extending between the first lower end and the first upper end defining a primary chamber. The beverage brewing apparatus further may have a second container connected to the first container, the second container having a second lower end, a second upper end, and a second sidewall extending between the second lower end and the second upper end defining a secondary chamber. A lid may enclose the first upper end and has a plunger movable relative to the lid, the plunger being movably disposed between the first upper end and the first lower end. The secondary chamber may be in fluid communication with the primary chamber via a passage proximate to the first lower end and the second lower end chamber.

In other examples of the present disclosure, the passage may have a filter element. The filter element may be a mesh filter. The filter element may be removable from the passage. At least a portion of the first sidewall may be connected to at least a portion of the second sidewall. The first container may be substantially parallel to the second container along a longitudinal axis of the first container. The second container may have a pouring spout formed on at least a portion of the second upper end. The plunger may have a filter. The filter may be configured to permit a flow of liquid therethrough and substantially inhibit a passage of solid material therethrough when the plunger moves from the first upper end toward the first lower end. The lid may be removably engageable with the first upper end. A handle may be positioned opposite the second container. The first lower end and the second lower end may be closed. The first upper end the second upper end may be open. The first container may have a substantially circular cross-sectional shape. The first container may have a same cross-sectional shape as the second container. The first container may have a different cross-sectional shape than the second container. The first container may have at least one indicator line. At least one of the first container and the second container may be made from plastic, glass, metal and/or any other material or a combination thereof. At least one of the first container and the second container may be made from a transparent, translucent and/or opaque material or a combination thereof.

In other examples of the present disclosure, a beverage brewing apparatus may include a first container having a first closed end, a first open end, and a first sidewall extending between the first closed end and the first open end defining a primary chamber. The beverage brewing apparatus may further include a second container connected to the first container, the second container being substantially parallel to the first container along a longitudinal axis of the first container and having a second closed end, a second open end, and a second sidewall extending between the second closed end and the second open end defining a secondary chamber. A lid may enclose the first open end and having a plunger movable relative to the lid, the plunger being movably disposed between the first open end and the first closed end. The secondary chamber may be in fluid communication with the primary chamber via a passage proximate to the first closed end and the second closed end. The plunger may have a filter configured to permit a flow of liquid therethrough and substantially inhibit a passage of solid material therethrough when the plunger moves from the first open end toward the first closed end.

Various other aspects of the present invention are recited in one or more of the following clauses:

Clause 1: A beverage brewing apparatus comprising: a first container having a first lower end, a first upper end, and a first sidewall extending between the first lower end and the first upper end defining a primary chamber; a second container connected to the first container, the second container having a second lower end, a second upper end, and a second sidewall extending between the second lower end and the second upper end defining a secondary chamber; and a lid enclosing the first upper end and having a plunger movable relative to the lid, the plunger being movably disposed between the first upper end and the first lower end, wherein the secondary chamber is in fluid communication with the primary chamber via a passage proximate to the first lower end and the second lower end.

Clause 2: The beverage brewing apparatus of clause 1, wherein the passage has a filter element.

Clause 3. The beverage brewing apparatus of clause 2, wherein the filter element is a mesh filter.

Clause 4. The beverage brewing apparatus of clause 2 or 3, wherein the filter element is removable from the passage.

Clause 5. The beverage brewing apparatus of any of clauses 1-4, wherein at least a portion of the first sidewall is connected to at least a portion of the second sidewall.

Clause 6. The beverage brewing apparatus of any of clauses 1-5, wherein the first container is substantially parallel to the second container along a longitudinal axis of the first container.

Clause 7. The beverage brewing apparatus of any of clauses 1-6, wherein the second container has a pouring spout formed on at least a portion of the second upper end.

Clause 8. The beverage brewing apparatus of any of clauses 1-7, wherein the plunger has a filter.

Clause 9. The beverage brewing apparatus of clause 8, wherein the filter is configured to permit a flow of liquid therethrough and substantially inhibit a passage of solid material therethrough when the plunger moves from the first upper end toward the first lower end.

Clause 10. The beverage brewing apparatus of any of clauses 1-9, wherein the lid is removably engageable with the first upper end.

Clause 11. The beverage brewing apparatus of any of clauses 1-10, further comprising a handle positioned opposite the second container.

Clause 12. The beverage brewing apparatus of any of clauses 1-11, wherein the first lower end and the second lower end are closed.

Clause 13. The beverage brewing apparatus of any of clauses 1-12, wherein the first upper end the second upper end are open.

Clause 14. The beverage brewing apparatus of any of clauses 1-13, wherein the first container has a substantially circular cross-sectional shape.

Clause 15. The beverage brewing apparatus of any of clauses 1-14, wherein the first container has a same cross-sectional shape as the second container.

Clause 16. The beverage brewing apparatus of any of clauses 1-15, wherein the first container has the same or different cross-sectional shape than the second container.

Clause 17. The beverage brewing apparatus of any of clauses 1-16, wherein the first container has at least one indicator line.

Clause 18. The beverage brewing apparatus of any of clauses 1-7, wherein at least one of the first container and the second container is made from plastic, glass, metal and/or any other material or a combination thereof.

Clause 19. The beverage brewing apparatus of any of clauses 1-18, wherein at least one of the first container and the second container is made from a transparent, translucent, opaque material or a combination thereof.

Clause 20. A beverage brewing apparatus comprising: a first container having a first closed end, a first open end, and a first sidewall extending between the first closed end and the first open end defining a primary chamber; a second container connected to the first container, the second container being substantially parallel to the first container along a longitudinal axis of the first container and having a second closed end, a second open end, and a second sidewall extending between the second closed end and the second open end defining a secondary chamber; and a lid enclosing the first open end and having a plunger movable relative to the lid, the plunger being movably disposed between the first open end and the first closed end, wherein the secondary chamber is in fluid communication with the primary chamber via a passage proximate to the first closed end and the second closed end, and wherein the plunger has a filter configured to permit a flow of liquid therethrough and substantially inhibit a passage of solid material therethrough when the plunger moves from the first open end toward the first closed end.

Further details and advantages of the various examples described in detail herein will become clear upon reviewing the following detailed description of the various examples in conjunction with the accompanying drawing figures.

### BRIEF DESCRIPTION OF THE DRAWINGS

FIG. 1 is a front perspective view of a beverage brewing apparatus in accordance with one example of the present disclosure;

FIG. 2 is a side cross-sectional view of the beverage brewing apparatus of FIG. 1 taken along line A-A with a plunger of the beverage brewing apparatus shown in a first position;

FIG. 3 is a side cross-sectional view of the beverage brewing apparatus of FIG. 1 taken along line A-A with the plunger of the beverage brewing apparatus shown in a second position;

FIG. 4 is a top cross-sectional view of the beverage brewing apparatus of FIG. 1 taken along line B-B;

FIG. 5 is front perspective view of the beverage brewing apparatus of FIG. 1 shown along with an optional handle; and

FIG. 6 is a side of the beverage brewing apparatus of FIG. 5 with a plunger of the beverage brewing apparatus shown in a first position;

FIG. 7 is a view of the beverage brewing apparatus of FIG. 5 with a plunger of the beverage brewing apparatus shown in a second position;

FIG. 8 is front perspective view of the beverage brewing apparatus of FIG. 5 shown in a pouring configuration.

### DETAILED DESCRIPTION OF THE INVENTION

The illustrations generally show preferred and non-limiting examples of the apparatus and methods of the present disclosure. While the description presents various aspects of the apparatus, it should not be interpreted in any way as limiting the disclosure. Furthermore, modifications, concepts, and applications of the disclosure's aspects are to be interpreted by those skilled in the art as being encompassed, but not limited to, the illustrations and descriptions herein.

The following description is provided to enable those skilled in the art to make and use the described examples contemplated for carrying out the disclosure. Various modifications, equivalents, variations, and alternatives, however, will remain readily apparent to those skilled in the art. Any and all such modifications, variations, equivalents, and alternatives are intended to fall within the spirit and scope of the present disclosure.

For purposes of the description hereinafter, the terms “upper”, “lower”, “right”, “left”, “vertical”, “horizontal”, “top”, “bottom”, “lateral”, “longitudinal”, and derivatives thereof shall relate to the disclosure as it is oriented in the drawing figures.

As used herein, the term “substantially parallel” means a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

It is to be understood, however, that the disclosure may assume alternative variations and step sequences, except where expressly specified to the contrary. It is also to be understood that the specific devices and processes illustrated in the attached drawings, and described in the following specification, are simply exemplary aspects of the disclosure. Hence, specific dimensions and other physical characteristics related to the examples disclosed herein are not to be considered as limiting.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise.

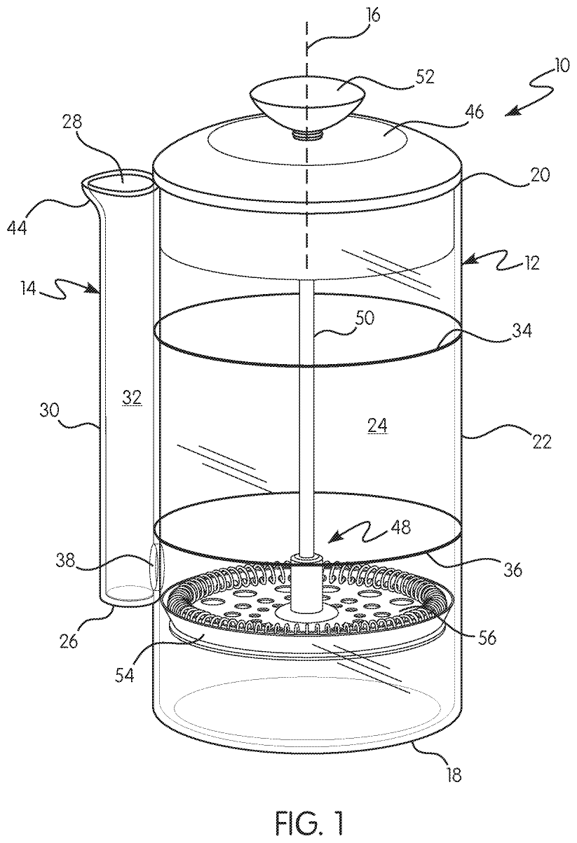

Referring to the drawings, in which like reference characters refer to the like parts throughout the several views thereof, FIG. 1 illustrates a beverage brewing apparatus 10 in accordance with one example of the present invention. Generally, the beverage brewing apparatus 10 is configured as a French press coffee maker and is configured for brewing a coffee beverage from ground coffee beans. The beverage brewing apparatus 10 includes a first container 12 and a second container 14. The first container 12 and the second container 14 may be made from any material that is impervious to liquid and/or gas, such as glass, plastic, or metal. In one example, the first container 12 and the second container 14 may be made of one or more than one of the following representative materials: polypropylene, polyethylene terephthalate (PET), glass, stainless steel, or any other materials or combinations thereof. The first container 12 and the second container 14 may be made from same or different materials. In some examples, at least one of the first container 12 and the second container 14 may be made from a transparent material.

With continued reference to FIG. 1, at least a portion of the first container 12 is connected to at least a portion of the second container 14. In some examples, the first container 12 may be monolithically formed with the second container 14. In other examples, the first container 12 may be removably or non-removably connected to the second container 14. For example, one or more clips or other attachment mechanisms may be provided on one or both of the first container 12 and the second container 14 for removably connecting the first container 12 with the second container 14. Alternatively, the first container 12 and the second container 14 may be formed separately and non-removably joined together using, for example, adhesive, welding, or other attachment mechanism. In some examples, the first container 12 and the second container 14 may be arranged substantially parallel to one another in a direction of a longitudinal axis 16 of the first container 12.

With continued reference to FIG. 1, the first container 12 has a first lower or closed end 18 (hereinafter referred to as “first closed end 18”) and a first upper or open end 20 (hereinafter referred to as “first open end 20”) with a first sidewall 22 extending between the first closed end 18 and the first open end 20 along the longitudinal axis 16. The first sidewall 22 defines a first or primary chamber 24. The first or primary chamber 24 has a minimum intended fill volume and a maximum intended fill volume, as discussed herein, and is configured as a primary brewing chamber. Similar to the first container 12, the second container 14 has a second lower or closed end 26 (hereinafter referred to as “second closed end 26”) and a second upper or open end 28 (hereinafter referred to as “second open end 28”) with a second sidewall 30 extending between the second closed end 26 and the second open end 28. The second sidewall 30 defines a second or secondary chamber 32.

With continued reference to FIG. 1, the first container 12 has a first indicator line 34 indicating a maximum intended fill volume. The first container 12 further has a second indicator line 36 indicating a minimum intended fill volume, as described herein. The first indicator line 34 and/or the second indicator line 36 may extend around at least a portion of outer circumference of the first container 12. The first indicator line 34 and the second indicator line 36 provide a visual indication to the user regarding a maximum or minimum intended fill volume of the first container 12. In some examples, the first indicator line 34 and the second indicator line 36 may be substantially perpendicular relative to the longitudinal axis 16 of the first container 12 to indicate the respective maximum and minimum intended fill volumes when the beverage brewing apparatus 10 is placed on a level surface. In other examples, the second indicator line 36 may be angled relative to the longitudinal axis 16 of the first container 12 to indicate the minimum intended fill volume when the beverage brewing apparatus 10 is in a pouring orientation.

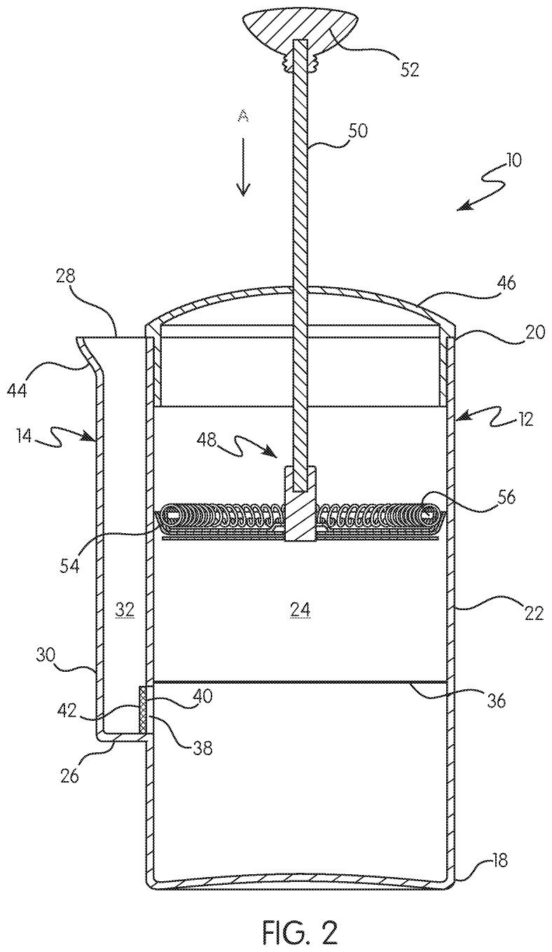

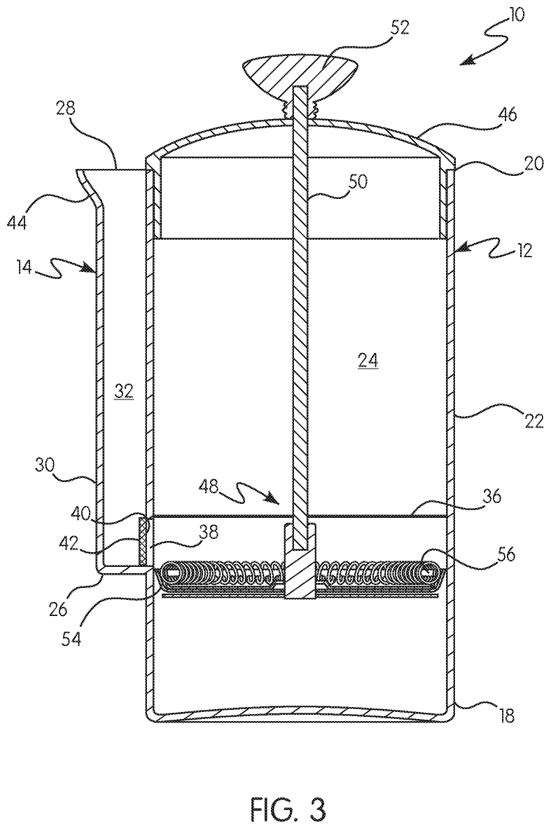

With reference to FIGS. 2-3, the secondary chamber 32 is in fluid communication with the primary chamber 24 by way of a passage 38. The passage 38 is positioned proximate to the first closed end 18 of the first container 12 and the second closed end 26 of the second container 14. In some examples, the passage 38 is formed as an opening in the first sidewall 22 and the second sidewall 30. In other examples, the passage 38 may be a fluid conduit (not shown) connecting the first sidewall 22 and the second sidewall 30. The passage 38 may be positioned about 1⅜ in. to about 1¾ in. above the first closed end 18 of the first container 12. The passage 38 may have a cross-sectional area of about ⅜ in.² to about ¾ in.². The passage 38 may be positioned such that the passage 38 is between the second indicator line 36 and the first closed end 18 of the first container 12.

With continued reference to FIGS. 2-3, at least a portion of the first sidewall 22 is connected to at least a portion of the second sidewall 30. In some examples, the first container 12 is connected to the second container 14 along the entire length of contact between the first sidewall 22 and the second sidewall 30, except at the location of the passage 38. In other examples, the first container 12 may be connected to the second container 14 along predetermined portions of the first sidewall 22 and the second sidewall 30. In further examples, one or more struts (not shown) connected to the first sidewall 22 and the second sidewall 30 may connect the first container 12 with the second container 14.

With continued reference to FIGS. 2-3, the passage 38 may have a filter element 40 configured to permit flow of liquid therethrough and substantially inhibit a passage of solid material therethrough. In some examples, the filter element 40 may be a mesh filter. The filter element 40 may be removable from the passage 38 to allow for cleaning of the filter element 40. In other examples, the filter element 40 may be non-removably connected to the passage 38. The filter element 40 desirably includes a plurality of openings 42 sized to prevent the passage of solid material, such as coffee grounds, of predetermined size. In some examples, the openings 42 of the filter element 40 may be about 1/32 in. to about 1/16 in. The filter element 40 may be made from any suitable material, such as metal, cloth, paper, or other suitable material. In some examples, the filter element 40 may be a multi-stage filter element, wherein a plurality of filter elements are disposed in series to allow for filtration in stages. In such examples, the filter elements 40 may have increasingly smaller openings 42 in a direction of flow from the primary chamber 24 toward the secondary chamber 32.

With continued reference to FIGS. 2-3, the second container 14 has a pouring spout 44 at the second open end 28. The pouring spout 44 may be shaped to direct fluid to a terminal edge of the pouring spout 44 during pouring of the liquid from the beverage brewing device 10. The pouring spout 44 may be shaped to prevent the spillage of liquid during pouring.

With continued reference to FIGS. 2-3, the beverage brewing device 10 further has a lid 46 enclosing the first open end 20 of the first container 12. In some examples, the lid 46 may be configured to enclose at least a portion of the second open end 28 of the second container 14. The lid 46 may be removably connected to the beverage brewing device 10. In some examples, the lid 46 may be dimensioned to fit closely against an inner surface of the first sidewall 22 of the first container 12. The lid 46 includes a plunger assembly 48 movable relative to the lid 46 between a first or raised position (FIG. 2) and a second or lowered position (FIG. 3). The plunger assembly 48 includes a shaft 50 protruding through an opening on the lid 46. While FIGS. 2-3 illustrate the shaft 50 as a cylindrical rod, other shapes of the shaft 50 are not precluded. A knob 52 is provided at an upper end of the shaft 50 for moving the shaft 50 between the raised position and the lowered position. A disc 54 is provided a lower end of the shaft 50. The disc 54 is desirably sized such that at least a portion of the disc 54 is in direct physical contact with an inner surface of the first sidewall 22 of the first container 12. The disc 54 has a filter element 56 that, as the plunger assembly 48 moves from the first or raised position (FIG. 2) toward the second or lowered position (FIG. 3), permits the flow of liquid therethrough but that substantially inhibits the passage of solid material therethrough. In the second or lowered position, the plunger assembly 48 is positioned such that the disc 54 is spaced apart from the first closed end 18 of the first container 12 by a predetermined distance. In this position, the knob 52 may contact an upper surface of the lid 46 to delimit the range of movement of the plunger assembly 46 in a downward direction toward the first closed end 18 of the first container 12. The user uses the knob 52 to lower the shaft 50 in a direction of arrow A is FIG. 2 such that the coffee grounds are trapped beneath the disc 54, and the resulting coffee extract which passes through the filter element 56 can be poured from the primary chamber 24 via the passage 38 and the secondary chamber 32, as described herein.

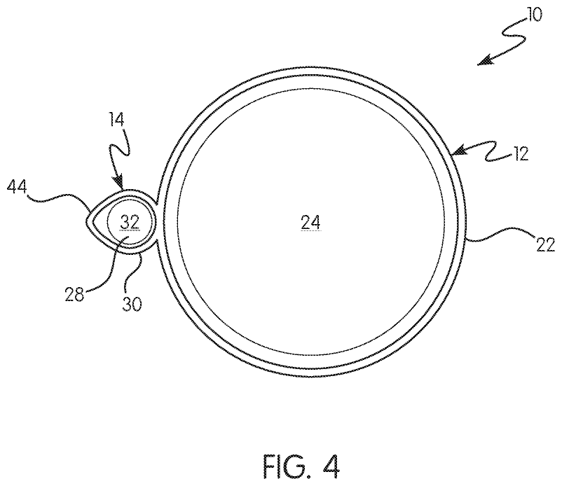

With reference to FIG. 4, the first container 12 can have any cross-sectional shape. While a substantially circular cross-sectional shape is shown in FIG. 4, other shapes, such as oval, are not precluded. In some examples where the first container 12 has a substantially circular cross-sectional shape, a diameter of the first container 12 can be about 2½ in. to about 4 in. The second container 14 can have a cross-sectional shape that is the same or different from the cross-sectional shape of the first container 12. In some examples, the first container 12 and the second container 14 can have a substantially circular cross-sectional shape. In other examples, the second container 14 can have an oval, triangular, or any other cross-sectional shape. In further examples, the second container 14 can be shaped to extend around at least a portion of an outer perimeter of the first container 12.

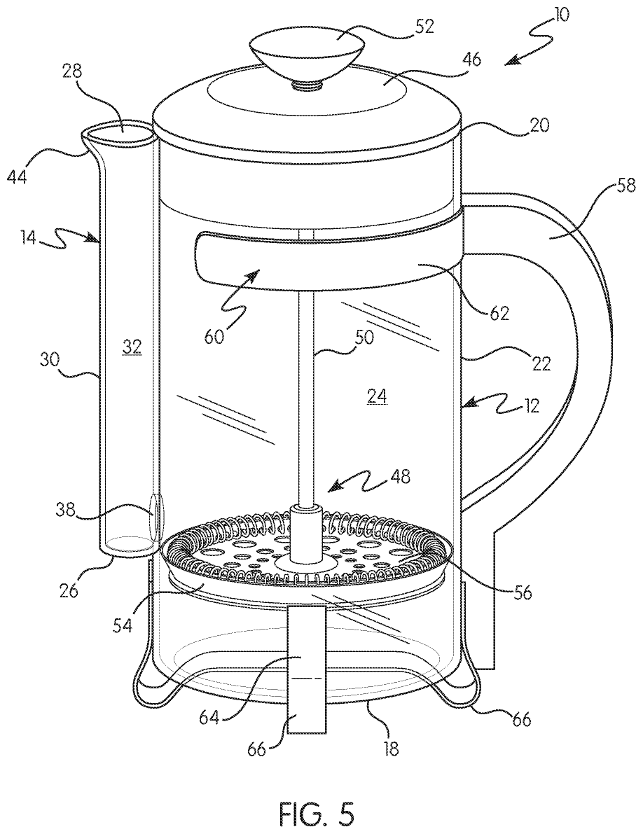

With reference to FIG. 5, the beverage brewing apparatus 10 has a handle 58 associated with at least one of the first container 12 and the second container 14. The handle 58 may be configured as a loop configured for providing a grasping surface for handling the beverage brewing apparatus 10, such as during pouring of liquid from the beverage brewing apparatus. The handle 58 is desirably positioned opposite the second container 14. In some examples, the handle 58 may be directly or indirectly connected to the first container 12. The handle 58 may be formed on a frame 60 that is shaped to receive at least a portion of the first container 12 and the second container 14. For example, the frame 60 may have an arm 62 that surrounds at least a portion of an outer perimeter of the first container 12. The frame 60 may further have a base 64 that supports at least a portion of the first closed end 18 of the first container 12. The base 64 may have a plurality of feet 66 to elevate the first closed end 18 of the first container 12 from a surface on which the beverage brewing apparatus 10 is supported. The arm 62 may be connected to the base 64 by the handle 58.

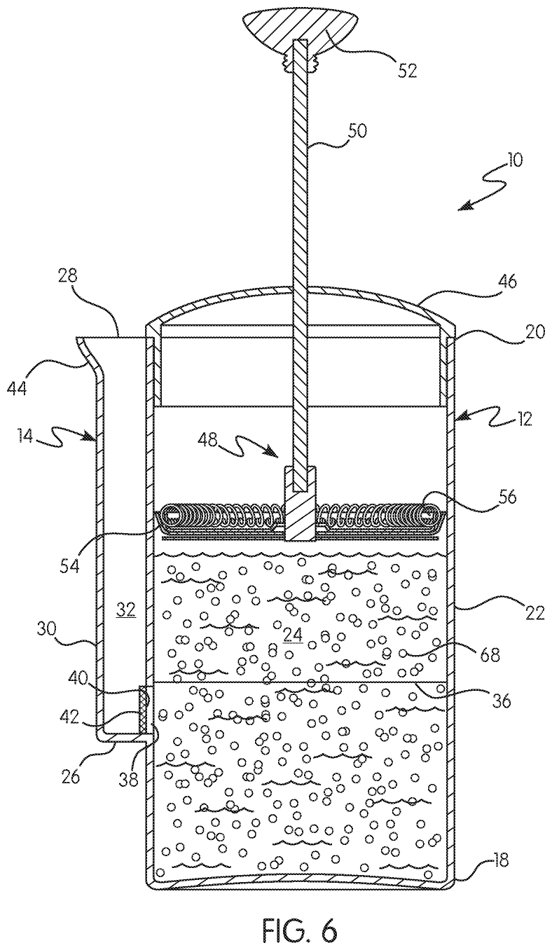

Having described the structure of the beverage brewing apparatus 10 with reference to FIGS. 1-5, a method of brewing and dispensing a beverage from the beverage brewing apparatus 10 will now be described with reference to FIGS. 6-8.

With initial reference to FIG. 6, a user removes the lid 46 along with the plunger assembly 48 and places a predetermined amount of an infusible solid material, such as coffee grounds, 68 in the primary chamber 24. Non-limiting examples of other infusible solid material to be placed in the primary chamber 24 include tea, cocoa powder, chocolate or any other infusible material. A liquid, such as hot water, is poured into the primary chamber 24. The user then replaces the lid 46 over the first container 12 to enclose the primary chamber 24, but leaves the plunger assembly 48 in the first or raised position so that the disc 54 is positioned at or above the top surface of the liquid. The liquid freely interacts with the coffee grounds 68, thereby forming an extract of the liquid and the coffee grounds 68. In the common example of coffee brewing, the extraction of coffee grounds 68 results in a coffee extract 70 and one or more low-density constituents 72, such as diterpenes. Such low-density constituents 72 float on top of the coffee extract 70 due to their lower density.

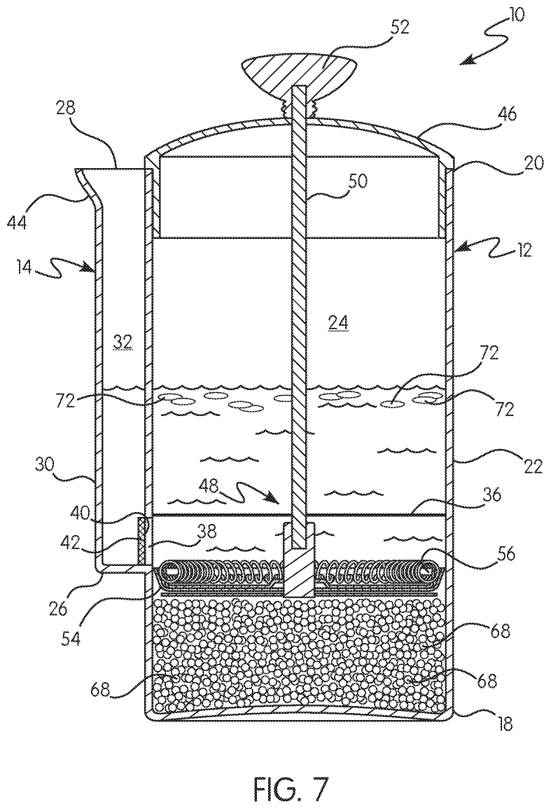

With reference to FIG. 7, the plunger assembly 48 is moved from the first or raised position to the second or lowered position by pressing on the knob 52 in a direction of arrow A shown in FIG. 2. Movement of the knob 52 in a downward direction also moves the disc 54, which forces the coffee grounds 68 in the coffee extract 70 in a downward direction, while allowing the coffee extract 70 to pass through the disc 54. With the disc 54 in the second or lowered position, the coffee extract 70 is prepared and ready for dispensing from the beverage brewing apparatus 10.

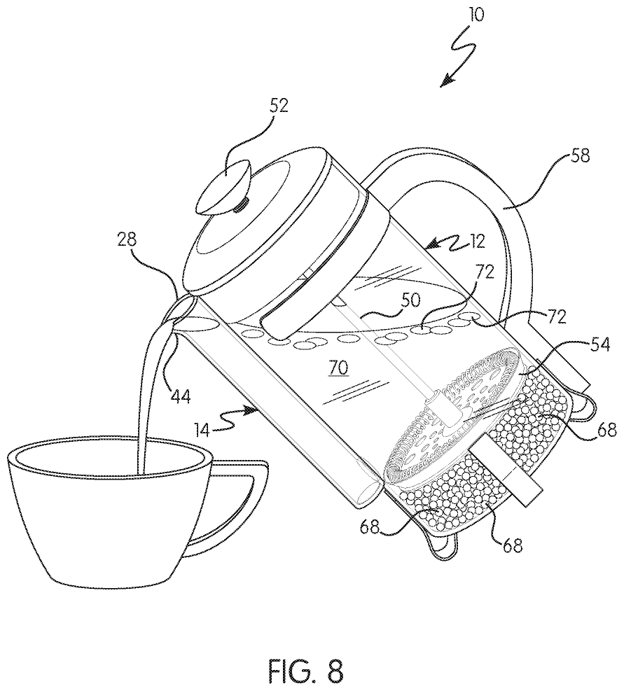

With reference to FIG. 8, the coffee extract 70 is dispensed by tilting the beverage brewing apparatus 10 to allow the coffee extract 70 to flow from the primary chamber 24 into the secondary chamber 32 through the passage 38. For example, the user may grasp the handle 58 and tilt the beverage brewing apparatus 10 such that liquid is delivered from the pouring spout 44 of the second container 14. Because the passage 38 is positioned lower than a top surface of the coffee extract 70, the coffee extract 70 flows from the bottom of the primary chamber 24 into the secondary chamber 32. In this manner, the low-density constituents 72 can remain floating on top of the coffee extract 70, while the coffee extract 70 is poured through the secondary chamber 32. The second indicator line 36 located on the first container 32 designates the level at which the coffee should no longer be poured to allow the low-density constituents 72 to remain in the primary chamber 24 and not enter the secondary chamber 32. The excess coffee extract 70 with the low-density constituents 72 may be discarded.

While examples of a coffee press with a lipids separation chamber were provided in the foregoing description, those skilled in the art may make modifications and alterations to these examples without departing from the scope and spirit of the disclosure. Accordingly, the foregoing description is intended to be illustrative rather than restrictive. The disclosure described hereinabove is defined by the appended claims, and all changes to the disclosure that fall within the meaning and the range of equivalency of the claims are to be embraced within their scope.

We claim:

1. A beverage brewing apparatus comprising:
a first container having a first lower end, a first upper end, and a first sidewall extending between the first lower end and the first upper end defining a primary chamber;
a second container connected to the first container, the second container having a second lower end, a second upper end, and a second sidewall extending between the second lower end and the second upper end defining a secondary chamber; and
a lid enclosing the first upper end and having a plunger movable relative to the lid, the plunger being movably disposed between the first upper end and the first lower end,
wherein the secondary chamber is in fluid communication with the primary chamber via a passage proximate to the first lower end and the second lower end.

2. The beverage brewing apparatus of claim 1, wherein the passage has a filter element.

3. The beverage brewing apparatus of claim 2, wherein the filter element is a mesh filter.

4. The beverage brewing apparatus of claim 2, wherein the filter element is removable from the passage.

5. The beverage brewing apparatus of claim 1, wherein at least a portion of the first sidewall is connected to at least a portion of the second sidewall.

6. The beverage brewing apparatus of claim 1, wherein the first container is substantially parallel to the second container along a longitudinal axis of the first container.

7. The beverage brewing apparatus of claim 1, wherein the second container has a pouring spout formed on at least a portion of the second upper end.

8. The beverage brewing apparatus of claim 1, wherein the plunger has a filter.

9. The beverage brewing apparatus of claim 8, wherein the filter is configured to permit flow of liquid therethrough and substantially inhibit a passage of solid material therethrough when the plunger moves from the first upper end toward the first lower end.

10. The beverage brewing apparatus of claim 1, wherein the lid is removably engageable with the first upper end.

11. The beverage brewing apparatus of claim 1, further comprising a handle positioned opposite the second container.

12. The beverage brewing apparatus of claim 1, wherein the first lower end and the second lower end are closed.

13. The beverage brewing apparatus of claim 1, wherein the first upper end the second upper end are open.

14. The beverage brewing apparatus of claim 1, wherein the first container has a substantially circular cross-sectional shape.

15. The beverage brewing apparatus of claim 1, wherein the first container has a same cross-sectional shape as the second container.

16. The beverage brewing apparatus of claim 1, wherein the first container has a different cross-sectional shape than the second container.

17. The beverage brewing apparatus of claim 1, wherein the first container has at least one indicator line.

18. The beverage brewing apparatus of claim 1, wherein at least one of the first container and the second container is made from plastic, glass, metal, or a combination thereof.

19. The beverage brewing apparatus of claim 1, wherein at least one of the first container and the second container is made from a transparent material, a translucent material, an opaque material, or a combination thereof.

20. A beverage brewing apparatus comprising:
a first container having a first closed end, a first open end, and a first sidewall extending between the first closed end and the first open end defining a primary chamber;
a second container connected to the first container, the second container being substantially parallel to the first container along a longitudinal axis of the first container and having a second closed end, a second open end, and a second sidewall extending between the second closed end and the second open end defining a secondary chamber; and
a lid enclosing the first open end and having a plunger movable relative to the lid, the plunger being movably disposed between the first open end and the first closed end,
wherein the secondary chamber is in fluid communication with the primary chamber via a passage proximate to the first closed end and the second closed end, and
wherein the plunger has a filter configured to permit a flow of liquid therethrough and substantially inhibit a passage of solid material therethrough when the plunger moves from the first open end toward the first closed end.
